(19) United States
(12) Patent Application Publication
(10) Pub. No.: US 2025/0250079 A1
(43) Pub. Date: Aug. 7, 2025

(54) CHILDPROOF PILL CONTAINER

(71) Applicant: E-LINK PLASTIC & METAL INDUSTRIAL CO., LTD., NEW TAIPEI CITY (TW)

(72) Inventor: YOU LIN WANG, NEW TAIPEI CITY (TW)

(21) Appl. No.: 18/768,958

(22) Filed: Jul. 10, 2024

(30) Foreign Application Priority Data
Feb. 1, 2024 (CN) 202420249485.7

(51) Int. Cl. B65D 50/06; A61J 1/14; B65D 25/04; B65D 43/16; B65D 51/18; B65D 51/24

(52) U.S. Cl. CPC B65D 50/061; A61J 1/1412; B65D 25/04; B65D 43/16; B65D 51/18; B65D 51/245; B65D 2215/04

(57) ABSTRACT

A childproof pill container has a top lid, an upper lid, a box body, a bottom lid, and a childproof lock. The upper lid is movably mounted below the top lid and has a first through hole. The box body is mounted below the upper lid and has a second through hole. The bottom lid is mounted below the box body and has a third through hole. The childproof lock includes a rotatable member and an accessory. The rotatable member is mounted through the first through hole, the second through hole and the third through hole and contact the top lid. The rotatable member comprises a first block. The accessory comprises a first opening corresponding to the first block. When the first block is aligned with the first opening, the rotatable member can move upwardly to push the top lid, so the childproof pill container can be opened.

### BACKGROUND OF THE INVENTION

### 1. Field of the Invention

The present invention relates to a childproof pill container.

### 2. Description of the Prior Arts

Medication safety for children has always been a major concern for parents. The reasons behind the hidden hazards of children's medication are: on one hand, there are few varieties and specifications of children's medicines on the market; on the other hand, children are prone to accidentally take medicines. At present, the safety packaging of children's medicines has not received enough attention. Most medicine packaging does not protect children from accidentally taking the medicine, and the safety tips are generally simply reflected in the medicine instructions. Some medicines even omit the safety packaging in order to save costs. But what is daunting is that according to the results of the 2014 “Safe Medication Use in Children Survey” conducted by Safe Kids Worldwide, 99% of children can open a regular pill container within two seconds. Therefore, it is necessary to develop a pill container that has the function of preventing children from accidentally taking the medicine and ensuring children's medication safety.

To overcome the shortcomings, the present invention provides a childproof pill container to mitigate or obviate the aforementioned problems.

### SUMMARY OF THE INVENTION

The main objective of the present invention is to provide a childproof pill container that is used to prevent children from accidentally taking medicine, and to ensure children's medicine safety.

The childproof pill container has a top lid, an upper lid, a box body, a bottom lid, and a childproof lock. The top lid is movably mounted above the upper lid. The box body is mounted below the upper lid. The bottom lid is mounted below the bottom of the box body. The childproof lock includes a rotatable member and an accessory.

The upper lid comprises a first through hole, and the box body comprises a second through hole corresponding to the first through hole in position. The bottom lid comprises a third through hole corresponding to the second through hole in position. The rotatable member is mounted through the first through hole, the second through hole and the third through hole and contacts the bottom of the top lid.

The rotatable member comprises a first block. The top end of the accessory comprises a first opening corresponding in shape to the first block of the rotatable member. When the first block is aligned with the first opening, the rotatable member is capable of moving upwardly to push the top lid, so that the pill container can be opened.

The whole process of opening the childproof pill container requires rotating and pushing the rotatable member, increasing the difficulty of opening the pill container for children, preventing children from taking medicine by mistake, and ensuring the children's medication safety.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a childproof pill container in accordance with the present invention;

FIG. 2 a perspective view of the childproof pill container in FIG. 1;

FIG. 3 an exploded view of the childproof pill container in FIG. 1;

FIG. 4 a cross-sectional view of the childproof pill container in FIG. 1; and

FIG. 5 a cross-sectional view of the childproof pill container in FIG. 1.

### DETAILED DESCRIPTION OF THE PREFERRED EMBODIMENTS

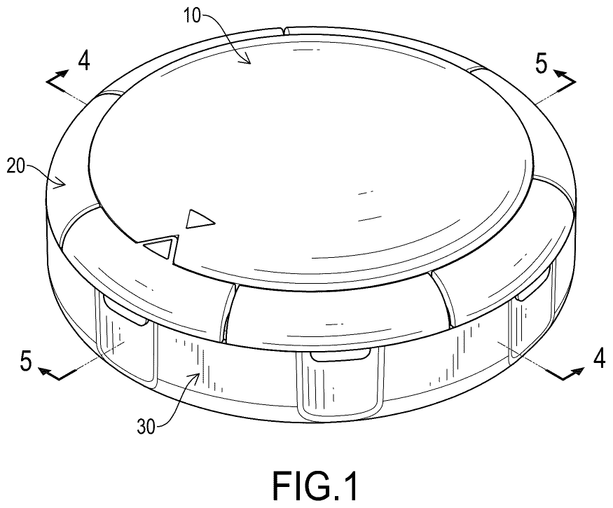

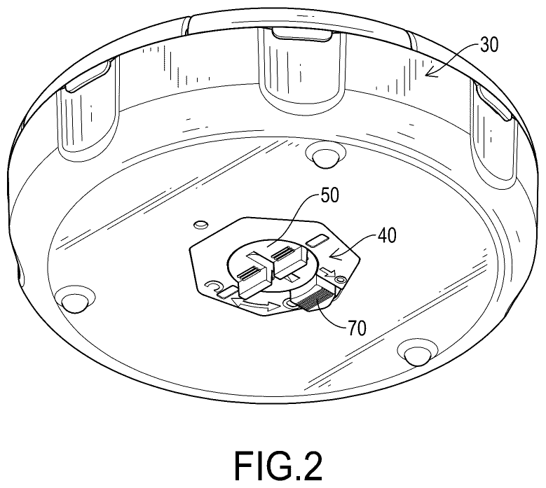

With reference to FIG. 1 and FIG. 2, a childproof pill container in accordance with the present invention comprises a top lid 10, an upper lid 20, a box body 30, a bottom lid 40, and a childproof lock.

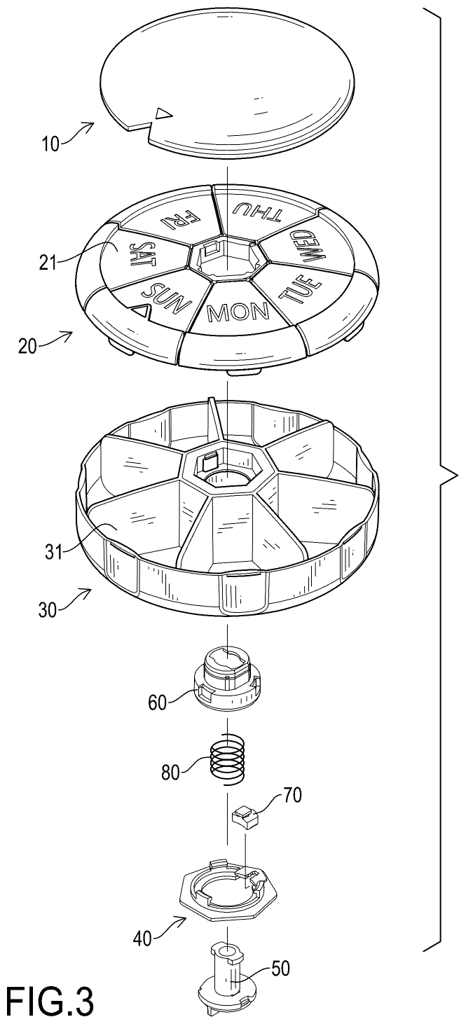

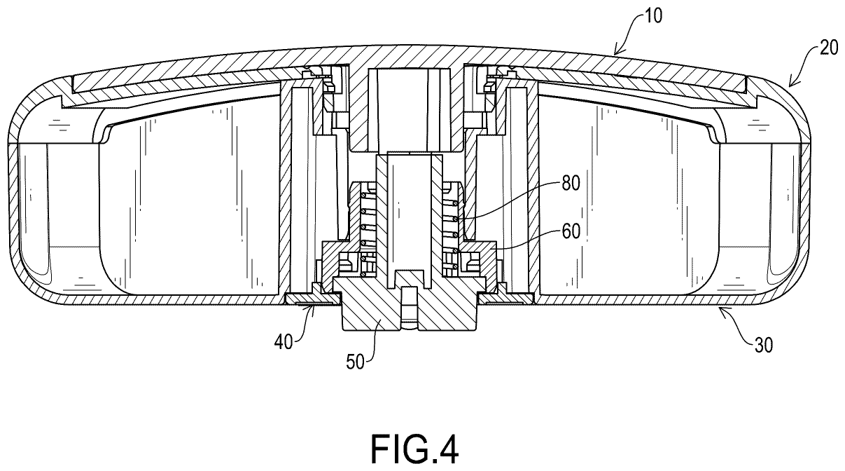

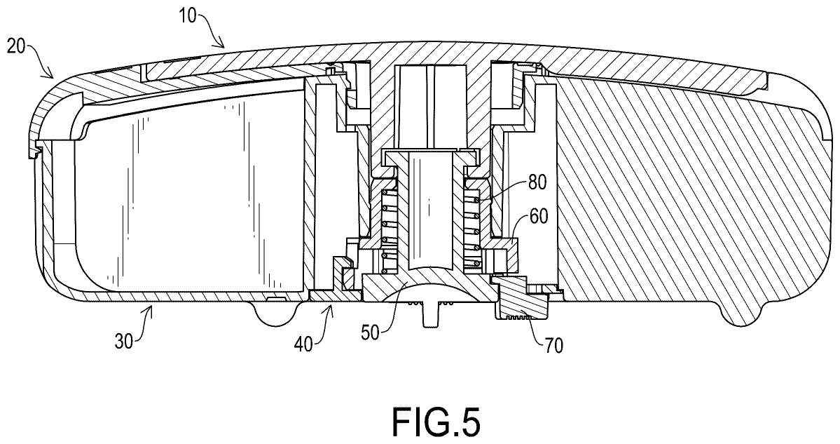

With reference to FIG. 3 to FIG. 5, the top lid 10 is used to secure the upper lid 20 and is movably mounted above the upper lid 20, so that the upper lid 20 cannot be opened at will. The upper lid 20 is used to close the box body 30, the box body 30 is mounted below the upper lid 20, and the upper lid 20 and the box body 30 are combined to form at least one sealed medicine storage space. The bottom lid 40 is mounted below the bottom of the box body 30 and is used to fix the childproof lock. In other words, from the bottom to the top, the childproof pill container sequentially comprises the bottom lid 40, the box body 30, the upper lid 20 and the top lid 10. The childproof lock comprises a rotatable member 50 and an accessory 60. The accessory 60 is a hollow columnar structure and is sleeved on the rotatable member 50, so that the rotatable member 50 can rotate and move up and down in the accessory 60.

The upper lid 20 comprises a first through hole, and the box body 30 comprises a second through hole corresponding in position to the first through hole. The bottom lid 40 comprises a third through hole corresponding in position to the second through hole. In other words, the first through hole, the second through hole and the third through hole correspond in position to each other. The rotatable member 50 is mounted through the first through hole, the second through hole and the third through hole and contacts the bottom of the top lid 10. The rotatable member 50 comprises a first block. The top end of the accessory 60 comprises a first opening corresponding in shape to the first block of the rotatable member 50. When the first block is aligned with the first opening, the rotatable member 50 is capable of moving upwardly to push the top lid 10, so that the childproof pill container can be opened.

In this embodiment, the bottom surface of the top lid 10 comprises a snap structure. When the snap structure is inserted into the first through hole, the top lid 10 will be fixed on the upper lid 20. When the first block of the rotatable member 50 is aligned with the first opening, the rotatable member 50 is capable of moving upwardly to contact the snap structure on the bottom surface of the top lid 10. The rotatable member 50 is capable of pushing the snap structure upwardly to disengage from the first through hole, thereby opening the pill container. In another embodiment, the bottom surface of the top lid 10 comprises a hollow column structure, and the hollow column structure comprises an aperture corresponding to the first opening. The rotatable member 50 comprises two first blocks in the vertical direction. One of the first blocks snaps into the hollow column structure of the top lid 10, and the other first block snaps into the accessory 60, making the childproof pill container unable to be opened when closed; when the two first blocks are respectively aligned with the top lid 10 and the first opening of the accessory 60, the rotatable member 50 can be pushed upwardly such that the top lid 10 departs from the aperture, and at the same time the top lid 10 disengages from the rotatable member 50, allowing the childproof pill container to be opened.

In this embodiment, with the rotatable member 50 and the accessory 60 in the childproof lock installed in the top lid 10, the upper lid 20, the box body 30, and the bottom lid 40, when the first block of the rotatable member 50 is rotated to fit into the first opening of the accessory 60, the rotatable member 50 can be pushed to eject the top lid 10, and then the upper lid 20 can be opened for accessing and discharging the medicines. The whole process of opening the childproof pill container requires rotating and pushing the rotatable member 50, increasing the difficulty of opening the pill container for children, preventing children from taking medicine by mistake, and improving the children's medication safety. The childproof lock replaces the conventional locking structure comprising a key, which prevents parents from being unable to find the key in time when they need to open the pill container. The childproof lock solves the problem of the conventional technology that the key cannot be carried around, and the safety and practicality of the pill container are improved.

In some embodiments, the bottom lid 40 comprises a second opening located on an inner surface of the bottom lid. A pick 70 is mounted in the second opening and corresponds in shape to the second opening. The pick 70 comprises a second block located at an end of the pick 70 near the rotatable member 50, and the bottom of the rotatable member 50 comprises a first recess corresponding to the second block.

The pick 70 is embedded in the second opening of the bottom lid 40, and the second block of the pick 70 can be inserted into the first recess of the rotatable member 50 to prevent the rotatable member 50 from moving and further enhance sealing of the pill container. To close the pill container, the pick 70 is moved inward. At this time, the second block of the pick 70 is inserted into the first recess, and the pick 70 and the bottom lid 40 remain horizontal. To open the pill container, the pick 70 can be pushed outward. At this time, the second block of the pick 70 leaves the first recess and remains perpendicular to the bottom lid 40, so that the rotatable member 50 can rotate. In this embodiment, a switch is added to the rotatable member 50 and has a double unlocking function to prevent children from accidentally opening the pill container. Unlocking the pick 70 needs an opening force of 2 kilograms, which is beyond children's capacity, thereby also increasing the difficulty for children to open the pill container and ensuring safe use of medicine for children.

In some embodiments, a spring 80 is mounted in the accessory 60, and the spring 80 is sleeved on the rotatable member 50. When the rotatable member 50 is pressed upward to open the top lid 10, the spring 80 will be compressed in the accessory 60. When the pressing stops, the rotatable member 50 will be restored to original position by the elastic force of the spring 80, which facilitates the closing of the pill container after taking the medicine and improves the convenience of medication administration.

In some embodiments, the box body 30 comprises multiple compartments 31 surrounding the second through hole to realize the dispensing of medicines and avoid cross-contamination of medicines. Precisely, in this embodiment, the box body 30 comprises seven compartments 31, each of the compartments 31 is evenly distributed around the second through hole in a fan shape, which is both aesthetically appealing and capable of containing seven-day medicine. Meanwhile, multiple compartments 31 can also be formed into the box body 30 in an integrated manner by molding, so that the box body 30 is more sealed.

In some embodiments, the upper lid 20 comprises multiple separate lids 21, the separate lids 21 correspond to the compartments 31, so that each of the compartments 31 can be opened independently to avoid affecting the medicines in other compartment 31. The separate lids 21 are connected in pairs near the first through hole, so that the entire upper lid 20 forms an integrated whole. The multiple separate lids 21 are separate away from the first through hole and do not interfere with each other, and each of the separate lids 21 can be folded upward so that a single compartment 31 can be opened. The upper surface of the separate lid 21 may be provided with a labeling area for distinguishing different medicines. Precisely, the middle portion of the edge of the separate lid 21 is also provided with a downwardly protruding block, which can be snapped together with the edge of the compartment 31 to form the entire upper lid 20. Meanwhile, the separate lids 21 can also be formed into the upper lid 20 by the integrated molding.

In some embodiments, the inner wall of the upper lid 20 is hollowed-out near the first through hole to be embedded into a block on the second through hole of the box body 30 so as to be tightly fastened to the box body 30.

In some embodiments, the upper lid 20 comprises a third block; the top lid 10 comprises a notch corresponding to the third block, so that the top lid 10 is fixed to the upper lid 20 and not easily rotated. In this embodiment, the upper lid 20 comprises a triangular third block, and the top lid 10 comprises a triangular notch corresponding to the triangular third block. When the whole top lid 10 is pressed against the upper lid 20 of the pill container, the triangular notch of the top lid 10 and the triangular third block of the upper lid 20 snap into each other, fixing each other securely.

The upper lid 20 comprises a second recess, the top lid 10 can be embedded in the second recess, so that the upper lid 20 is more closely integrated with the box body 30. The embedded structure is more difficult to open and improves the children's medication safety.

The shape of the box body 30 can be a cylinder, a cube, a cuboid, a square hexagonal column or a square heptagonal column, but its shape is not limited thereto. To improve the sealing and aesthetics of the pill container, the top lid 10, the upper lid 20, and the bottom lid 40 are selected to match or be in the same shape as the box body 30. In this embodiment, the top lid 10, the upper lid 20, the box body 30, and the bottom lid 40 are cylinders.

In some embodiments, a hollow cylindrical structure is provided at the center of the bottom of the top lid 10, and the hollow cylindrical structure corresponds to the accessory 60 in shape. When the top lid 10 is closed, the hollow cylindrical structure is inserted into the gap between the accessory 60 and the through holes and is stuck in the gap to prevent the pill container from being opened at will. In some embodiments, the shape of the hollow cylindrical structure can be a cylinder, a cube, a cuboid, a regular hexagonal prism or a regular heptagonal prism, but its shape is not limited thereto. Precisely, the shape of the hollow cylindrical structure can be a regular heptagonal column matched with the seven compartments 31. The hollow column structure is a prism, which is difficult to rotate and can improve the stability and tightness of the pill container.

In some embodiments, the upper lid 20 and the box body 30 are made of polypropylene (PP) to ensure the safety of the pill container; the top lid 10, the bottom lid 40, the rotatable member 50, the accessory 60, and the pick 70 are all made of ABS (propylene-butadiene-styrene copolymer), which is easy to process; the spring 80 is made of stainless steel, which is rust resistant and can extend the service life of the pill container.

In some embodiments, the bottom of the rotatable member 50 comprises a third recess, which facilitates the user to rotate the rotatable member 50 with the help of a tool, which is more convenient for opening the pill container. Precisely, tools such as coins and keys can be used. To facilitate rotation to a suitable angle, the lower surface of the bottom lid 40 is provided with two marks corresponding to the position of the first opening. When the third recess is rotated to correspond to the two marks, that is, when the two marks and the third recess are aligned, the user can open the top lid 10 by rotating the rotatable member 50.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A childproof pill container comprising:
a top lid;
an upper lid mounted below the top lid, the top lid being movable with respect to the upper lid, and the upper lid comprising:
a first through hole penetrating through the upper lid;
a box body mounted below the upper lid and comprising:
a second through hole corresponding in position to the first through hole;
a bottom lid mounted below the box body and comprising:
a third through hole corresponding in position to the second through hole;
a childproof lock comprising:
a rotatable member mounted through the first through hole, the second through hole, and the third through hole, and the rotatable member being capable of abutting a bottom surface of the top lid and comprising a first block;
an accessory sleeved on the rotatable member and comprising:
a first opening located on a top of the accessory; the rotatable member being movable upward to push the top lid to open when the first opening is aligned with the first block.

2. The childproof pill container as claimed in claim 1, wherein
the bottom lid further comprises a second opening located on an inner surface of the bottom lid;
the childproof pill container comprises a pick located in and corresponding in shape to the second opening, and the pick comprises:
a second block located at an end of the pick, and said end being near the rotatable member; and
the rotatable member further comprises a first recess located on the bottom of the rotatable member, and the first recess corresponds in shape to the second block.

3. The childproof pill container as claimed in claim 1 further comprising a spring located in the hollow accessory and sleeved on the rotatable member.

4. The childproof pill container as claimed in claim 2 further comprising a spring located in the hollow accessory and sleeved on the rotatable member.

5. The childproof pill container as claimed in claim 1, wherein
the box body comprises multiple compartments evenly surrounding the second through hole; and
the upper lid comprises multiple separate lids and each of the separate lids corresponds to a respective one of the compartments.

6. The childproof pill container as claimed in claim 4, wherein
the box body comprises multiple compartments evenly surrounding the second through hole; and
the upper lid comprises multiple separate lids and each of the separate lids corresponds to a respective one of the compartments.

7. The childproof pill container as claimed in claim 1, wherein,
the upper lid comprises a third block located at an end of the top lid near the upper lid;
the top lid comprises a notch corresponding to the third block in shape.

8. The childproof pill container as claimed in claim 6, wherein,
the upper lid comprises a third block located at an end of the top lid near the upper lid;
the top lid comprises a notch corresponding to the third block in shape.

9. The childproof pill container as claimed in claim 1, wherein
the upper lid comprises a second recess and the top lid is embedded in the second recess.

10. The childproof pill container as claimed in claim 8, wherein
the upper lid comprises a second recess and the top lid is embedded in the second recess.

11. The childproof pill container as claimed in claim 1, wherein,
the top lid comprises a hollow column mounted on a center of the bottom surface of the top lid, and the hollow column corresponds to the accessory.

12. The childproof pill container as claimed in claim 10, wherein,
the top lid comprises a hollow column mounted on a center of the bottom surface of the top lid, and the hollow column corresponds to the accessory.
